(19) United States
(12) Patent Application Publication
(10) Pub. No.: US 2026/0278365 A1
(43) Pub. Date: Sep. 17, 2026

(54) APPARATUS, METHOD, SYSTEM, AND STORAGE MEDIUM FOR DEEP LEARNING OPERATION ON WORKLOADS WITH DYNAMIC SHAPES

(71) Applicant: Intel Corporation, Santa Clara, CA (US)

(72) Inventors: Zhennan Qin, Shanghai (CN); Jingze Cui, Shanghai (CN); Yijie Mei, Shanghai (CN); Jianhui Li, San Jose, CA (US)

(21) Appl. No.: 18/877,187

(22) PCT Filed: Sep. 20, 2022
(86) PCT No.: PCT/CN2022/120027

§ 371 Date: Dec. 19, 2024

(30) Foreign Application Priority Data
Jul. 25, 2022 (WO) PCT/CN2022/107707

(51) Int. Cl. G06N 3/08

(52) U.S. Cl. CPC G06N 3/08

(57) ABSTRACT

The application provides an apparatus, method, system and storage medium for a deep learning operation on workloads with dynamic shapes. The apparatus includes interface circuitry configured to obtain a profile of tensor shapes; and processing circuitry coupled to the interface circuitry and configured to: infer, from the profile of tensor shapes, a profile of parallel index ranges and a probability for each of the parallel index ranges; determine a set of candidate blocking factors for each of the parallel index ranges; and generate a kernel for the deep learning operation under each of the candidate blocking factors, the kernel for the operation comprising a parallel outer loop and an inner loop with a single-core kernel implementing a part of the deep learning operation working on corresponding parts of the workloads. (FIG. 1)

### CROSS-REFERENCE TO RELATED APPLICATIONS

The present application claims the priority to PCT international application No. PCT/CN2022/107707, entitled “HIGH PERFORMANCE DEEP LEARNING KERNEL GENERATION WITH PARTIAL SHAPE INFORMATION FOR DEEP LEARNING WORKLOAD” and filed on Jul. 25, 2022, which is incorporated herein by reference in its entirety.

### TECHNICAL FIELD

Embodiments described herein generally relate to artificial intelligence (AI) and machine learning (ML) technologies, and in particular, to an apparatus, method, system and storage medium for a deep learning operation on workloads with dynamic shapes.

### BACKGROUND

Deep learning compilers are often used as the backend for deep learning frameworks as runtime just-in-time (JIT) compilers. To improve efficiency, deep learning compilers specialize compilation for a specific input tensor shape. Usually, the compiled code is cached so that the compiled code can be reused for the same tensor shape. Unknown tensor shapes trigger a new compilation process, which caches the compiled code for future use.

The input tensor shape to deep learning models may change at run time. For example, in a cloud deployment scenario, a service may buffer a different number of requests and submit the buffered requests as a batch to a deep learning model with a variant batch size. The sentence length for natural language processing model may change. The possible number of objections for objection detection models may also change.

This approach causes two problems: bloated code cache and long compilation latency for unknown shapes. When the cached compiled code reaches a limit, the compiled code is typically recycled, which potentially causes more compilation and deteriorates overall performance.

For each of dynamic shape scenarios in deep learning, such us, machine vision, natural language processing and the like, not every dimension of the input tensor shape is changing at the runtime. For example, a dimension related to a model parameter is usually a constant, which presents a potential opportunity to improve the efficiency and optimize the performance of deep learning operations.

### SUMMARY

According to an aspect of the disclosure, an apparatus for a deep learning operation on workloads with dynamic shapes is provided. The apparatus includes interface circuitry configured to obtain a profile of tensor shapes; and processing circuitry coupled to the interface circuitry and configured to: infer, from the profile of tensor shapes, a profile of parallel index ranges and a probability for each of the parallel index ranges; determine a set of candidate blocking factors for each of the parallel index ranges; and generate a kernel for the deep learning operation under each of the candidate blocking factors, the kernel for the operation comprising a parallel outer loop and an inner loop with a single-core kernel implementing a part of the deep learning operation working on corresponding parts of the workloads.

According to another aspect of the disclosure, a method for a deep learning operation on workloads with dynamic shapes is provided. The method includes inferring, from a profile of tensor shapes, a profile of parallel index ranges and a probability for each of the parallel index ranges; determining a set of candidate blocking factors for each of the parallel index ranges; and generating a kernel for the deep learning operation under each of the candidate blocking factors, the kernel for the operation comprising a parallel outer loop and an inner loop with a single-core kernel implementing a part of the deep learning operation working on corresponding parts of the workloads.

Another aspect of the disclosure provides a machine readable storage medium having instructions stored thereon, which when executed by a machine cause the machine to perform the above method for the deep learning operation on workloads with dynamic shapes.

Another aspect of the disclosure provides a computing device including means for implementing the above method for the deep learning operation on workloads with dynamic shapes.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an overview of a system for a deep learning operation on workloads with dynamic shapes according to some embodiments of the disclosure;

FIG. 2 shows an exemplary pseudo code that can be used to determine a set of candidate blocking factors for each of parallel index ranges according to some embodiments of the disclosure;

FIG. 3 shows an exemplary kernel implementation of a compute-intensive operation by a traditional deep learning compilation method;

FIG. 4 shows a schematic diagram illustrating an implementation to parallelize compute-intensive operation on input tensors with dynamic shapes according to some embodiments of the disclosure;

FIG. 5 shows an exemplary pseudo code describing how a parallel loop for an parallel index can be transformed to parallelize a reduction index, according to some embodiments of the disclosure;

FIG. 6 shows an exemplary pseudo code for calculating a kernel cost for each candidate kernel, according to some embodiments of the disclosure;

FIG. 7 shows an exemplary pseudo code for selecting, for a determined parallel index range, a blocking factor from a set of pre-defined block factors, according to some embodiments of the disclosure;

FIG. 8A shows a flowchart of a process for generating kernels used for a deep learning operation on workloads with dynamic shapes, according to some embodiments of the disclosure;

FIG. 8B shows a flowchart of a process for performing the deep learning operation on input tensors using the kernels generated by the process of FIG. 8A, according to some embodiments of the disclosure;

FIG. 9 shows an exemplary pseudo code for generating a kernel for the Matmul operation by a traditional compiler according to some embodiments of the disclosure;

FIG. 10 shows an exemplary pseudo code for generating kernels used for the Matmul operation, for which a part of shape information is unknown, according to some embodiments of the disclosure;

FIG. 11 is a block diagram illustrating components, according to some example embodiments, able to read instructions from a machine-readable or computer-readable medium and perform any one or more of the methodologies discussed herein; and

FIG. 12 is a block diagram of an example processor platform in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

Deep learning workloads spend a considerable amount of time on compute-intensive operations, such as convolution (Conv) and General Matrix Multiplication (GEMM). Having an effective kernel for each operation may be critical to many deep learning application deployments.

To get the best code efficiency for compute-intensive kernels on artificial intelligence (AI) hardware with parallel processing units, a deep learning compiler needs to consider parallelism at the overall system level and the computing efficiency at the processing unit level. When the deep learning compiler decomposes a compute-intensive kernel to subtasks, the decomposition needs to ensure that there is enough subtask number for the load balancing of all processing units, and the subtask size must be significant enough to efficiently use one single parallel processing unit. However, these two optimization goals can be contradictory for a given compute size, more subtask number leads to small subtask size, and large subtask size leads to less subtask number. The existing deep learning compiler or performance library requires both input and output tensor shapes to decide the blocking factors and then generates specialized code for the given shapes.

One of previous solutions is to recompile a Conv or GEMM kernel for an input tensor with a new shape and cache the compiled code enabling it to be reused for another input tensor with the same shape. By this solution, an application may experience a long delay if it involves a new compilation under the hood. Sometimes, it could lead to a user experience issue since an end user may feel that the application is not running smoothly. Additionally, the excessive compilation could lead to excessive memory usage for the compiled code, which may cause an out of memory failure or damage the application performance.

In another previous solution, referred to as a “library solution”, a Conv or GEMM kernel is statically pre-built and thus recompilation overhead for the Conv or GEMM kernel is not involved. However, the library solution can only implement Conv and GEMM operations and is not able to compile and execute a graph of Deep Neural Networks (DNN) operations. As an example, the Math Kernel Library (MKL) provides a GEMM function with dynamic shape support, but doesn't allow the GEMM operation to be fused with a neighbor operation. The statically pre-built kernel library comes with an extra binary size and would not be applied to a use case where a user wants to reduce the compiled model package size including the dependent library. Further, the statically pre-build kernel library is not able to compile the whole graph and thus loses performance opportunities.

In related fields, use cases processing workloads with dynamic shapes are increasing. In order to solve at least some of the problems proposed by the mentioned two previous solutions, embodiments of the present disclosure provide an approach to generate kernels for a deep learning operation (such as a Conv operation, GEMM operation, a graph pf DNN operation and so forth) on workloads with dynamic shapes. Optionally, as a particular implementation, a part of shape information of the dynamic shapes may be known at compilation time. For example, some dimensions of input tensors may be specified as constant and the other dimensions may be dynamically changeable. The present disclosure can be used to reduce repetitive compilation without significantly sacrificing the performance of the compiled code.

In some embodiments, a range of single-core kernels is built firstly, which are specialized for pre-defined shape sizes, a subset of single-core kernels may be selected from the range of single-core kernels based on partial shape information, and a high-performance parallel code with multiple optional paths with these selected single-core kernels may be composed. At execution time, blocking factors may be determined based on full shape information of input tensors, and then one optimal path is chosen accordingly. The high performance code for dynamic tensor shapes generated by the approach of the present disclosure can be fused by the compiler with neighbor operations within a DNN graph. Techniques of the present disclosure can minimize the compilation time for model with dynamic input tensor shapes and can be used to support ahead of time compilation use case. These techniques can be incorporated into any deep learning compiler, such us the oneDNN Graph Compiler Beta by Intel®, to improve the performance of the deep learning compiler.

The disclosure describes a way to generate high performance deep learning kernel with unknown tensor shapes. The disclosure focusses on compute-intensive operations like matrix multiplication (Matmul) and Convolution (Conv), but can be applied to any operation that can be expressed a nested loop consisting a parallel loop and a reduction loop.

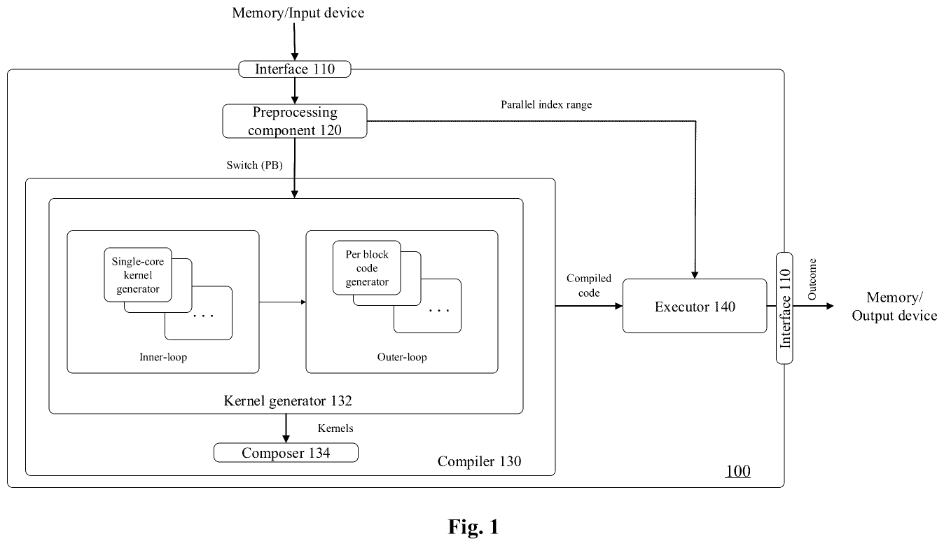

FIG. 1 shows an overview of a system 100 for a deep learning operation on workloads with dynamic shapes according to some embodiments of the disclosure.

It is to be noted that the “deep learning operation” used herein may refer to any operation involved in a deep learning application, such as a Conv operation, GEMM operation, a graph pf DNN operation and so forth, which is not limited specifically.

The number, capability, and/or capacity of elements of system 100 may vary, depending on whether system 100 is used as a stationary computing device (e.g., a server computer in a data center, a workstation, a desktop computer, etc.) or a mobile computing device (e.g., a smartphone, tablet computing device, laptop computer, game console, Internet of Things (IoT) device, etc.). In various implementations, the system 100 may include one or more components of a data center, a desktop computer, a workstation, a laptop, a smartphone, a tablet, a digital camera, a smart appliance, a smart home hub, a network appliance, and/or any other device/system that processes data.

As a simplified situation, the system 100 includes input/output (I/O) interface(s) 110, a preprocessing component 120, a compiler 130 and an executor 140.

The I/O interface(s) 110 may be configured to receive input data for the deep learning operation from a memory/storage device or input device and output an outcome of the deep learning operation to a memory/storage device or output device.

In some embodiments, one or more memories/storage devices may be included in the system 100 or may be coupled to the system 100. The memories/storage devices may include main memories, disk storage, or any suitable combination thereof. The memories/storage devices may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

In some embodiments, various I/O devices may be present within or connected to the system 100 via the I/O interface(s) 110. The input devices may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output devices may be included to show information or otherwise convey information, such as sensor readings, actuator position(s), or other like information. Data and/or graphics may be displayed on the out devices. The output devices may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 450. The output devices may also include speakers and/or other audio emitting devices, printer(s), and/or the like. Additionally or alternatively, sensor(s) may be used as the input devices (e.g., an image capture device, motion capture device, or the like) and one or more actuators may be used as the output devices (e.g., an actuator to provide haptic feedback or the like).

The input data for the deep learning operation may include data to indicate shape information of operators of the deep learning operation, e.g., tensors to describe the operators. In order to perform deep learning operation on workloads with dynamic shapes, it is assumed in the disclosure that the input data includes a profile of tensor shapes that describes every potential tensor shape of the workload.

As used herein, the term “profile of tensor shapes” can be explained to include all possible tensor shapes that can be conceived by those skilled in the related art. In practice, those skilled in the related art are able to select an appropriate cluster of tensor shapes to use as the profile of tensor shapes.

After the profile of tensor shapes is received, the preprocessing component 120 analyzes the profile of tensor shapes to infer, from the profile of tensor shapes, a profile of parallel index ranges and a probability for each of the parallel index ranges.

For given parallel index p₀, . . . , pₓ, the system 100 tries to minimize the number (denoted as φ) of blocking factors. Each blocking factor from the set {PB⁰ . . . PB^{φ}} represents a combination of blocking factors from each of parallel indexes, for example, PB⁰ can represent {PB⁰₀ . . . PB⁰ₓ}. Suppose there is N possible ways to block each parallel index, the number of all possible combination would be an exponential of N and the number of the parallel indexes, X, i.e., N^{x}. As each combination is associated with one kernel implementation, the large number of combinations can lead to significant binary size.

In the disclosure, it is supposed that the profile of parallel index ranges may be denoted as {P⁰ . . . P^{θ}}, and probability for each of the parallel index ranges may be denoted as {Prob⁰ . . . Prob^{θ}}.

The preprocessing component 120 determines a set of candidate blocking factors for each of the parallel index ranges. For example, the preprocessing component 120 may select for example, based on an estimated kernel cost corresponding to each potential blocking factor for each of the parallel index ranges, the set of candidate blocking factors that provide overall good performance for all possible shapes without bloating the binary size. The preprocessing component 120 may determine the set of candidate blocking factors for each of the parallel index ranges using blocking heuristic, which identifying a blocking factor for a given shape, core number, and microarchitecture information.

An exemplary algorithm for the preprocessing component 120 to determine the set of candidate blocking factors for each of the parallel index ranges can be described as follows.

Algorithm: selecting a number of blocking factors {PB⁰ . . . PB^{φ}}, which works the best for a given profile of parallel index ranges {P⁰ . . . p^{θ}}.

Input: the profile of parallel index ranges: {P⁰ . . . P^{θ}}, and associated probability {Prob⁰ . . . Prob^{θ}}; ¢ as a total number of parallel index blocking factor combinations; R as a reduction index range, uArch_info for micro-architecture information, and core_num for the number of cores.

Output: a number (φ) of blocking factors {PB⁰ . . . PB^{φ}}, which are estimated to have overall lowest kernel costs for the given profile of parallel index ranges {P⁰ . . . P^{θ}}.

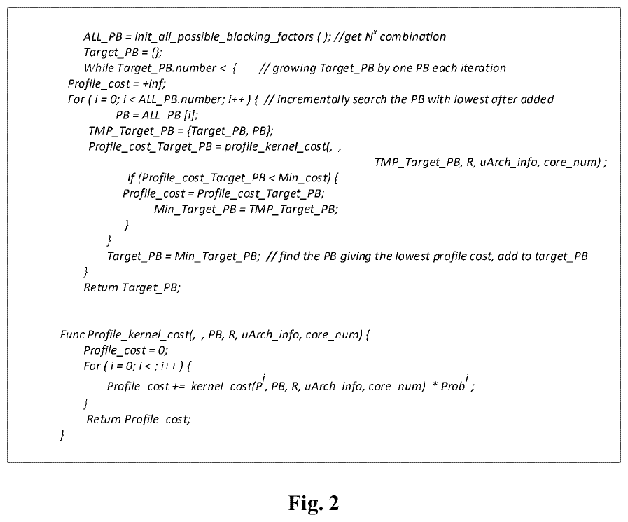

FIG. 2 shows an exemplary pseudo code that can be used to determine the set of candidate blocking factors for each of the parallel index ranges according to some embodiments of the disclosure.

After the set of candidate blocking factors for each of the parallel index ranges is determined, for each blocking factor in the set of the candidate blocking factors for each of the parallel index ranges, the compiler 130 is invoked to generate a kernel.

It is assumed that if there are θ parallel index ranges and φ candidate blocking factors for each parallel index range, there should be θφ kernels to be generated.

In an example, the compiler 130 may include a kernel generator 132 to generate each kernel. For the kernel generator 132, when a particular kernel is generated, a parallel index range, a reduction index range and a blocking factor are all known, it can generate the particular kernel just like performing the deep learning operation on input tensors with static shapes.

The following example is used to illustrate how the deep learning operation is performed on input tensors with static shapes.

$$C [ {p}_{0} , … , {p}_{x} ] = {Σ}_{{r}_{0} , … , {r}_{t}} ( A [ {i}_{0} , … , {i}_{y} ] * B [ {j}_{0} , … , {j}_{z} ] ) \qquad ( 1 )$$

Equation (1) shows a general form of a math equation for a deep learning operation on input tensors A and B, and C is the outcome of the operation. The deep learning operation may be any of Matmul, Conv, Pooling, Element-wise operation and the like. The indexes of the output tensor C are named parallel indexes, denoted as p₀, . . . , pₓ with P₀, . . . , Pₓ as their index range boundaries, and reduction indexes r₀, . . . , rₜ used to perform reduction are called with R₀, . . . , Rₜ as their index range boundaries. The input tensor A and B are indexed by tensor indexes, i₀, . . . , i_{y} or j₀, . . . , j_{z}.

In Equation (1), each index p₀, . . . , pₓ has an index range p₀={0 . . . P0-1}, . . . pₓ∈{0 . . . PX-1}, each index r₀, . . . , rₜ has an index range r₀∈{0 . . . R0-1}, . . . rₜ∈{0 . . . . RT-1}, and each index i from i₀, . . . , i_{y} or j from j₀, . . . , j_{z} is an affine expression of p₀, . . . , pₓ and r₀, . . . , rₜ, i.e., α*p+β*r+γ.

To simplify the description, the present disclosure use p to denote any parallel index and P as its index range upper boundary, use r to denote any reduction index and R as its index range upper boundary, and similarly use i and j to denote the tensor indexes. The tensor index can be map to the parallel index, the reduction index, or a combination of them. For example, for an input tensor of 2D Matmul, one matrix index maps to the parallel index, and the other maps to the reduction index. For an activation input tensor of 3D Conv, a tensor index for certain dimension is composed of both the parallel index and the reduction index. To be general, each tensor index can be represented as an affine expression of the parallel index and the reduction index. Particularly, in the deep learning domain, the reduction index range is usually constant, and the parallel index range may change as shapes of the input tensors change.

Equation (1) means that for each possible point in the index space of p and r, the multiplication result of tensor elements from A and B associated with that point is calculated, and then the multiplication results are reduced the along the reduction indexes to produce C.

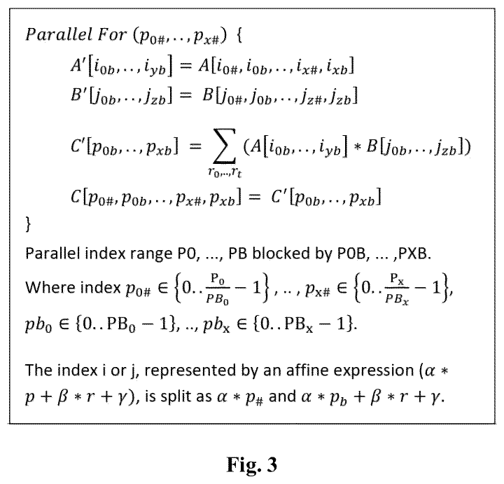

FIG. 3 shows an exemplary kernel implementation of the compute-intensive operation of Equation (1) by a traditional deep learning compilation method. As shown, for static shape input tensors, the tensor index ranges are given at compilation time, from which parallel index range (P) and reduction index range (R) can be inferred. The compiler blocks P with blocking factor PB and split parallel index p to p_{#} and p_{b}, with p=p_{#}*PB+p_{b}. The outer loop with parallel index p_{#} is fully parallelized and the inner loop with parallel index p_{b} are carried out on each single core. The math equation within the inner loop denotes a single-core kernel, which implements part of the original compute-intensive operation working on input and output sub-tensors. As the upper boundaries of parallel indexes p_{b} and reduction indexes r are all known, and the single-core kernel implementation is specialized for these index ranges and performs blocking and unrolling for the cache hierarchy and register files.

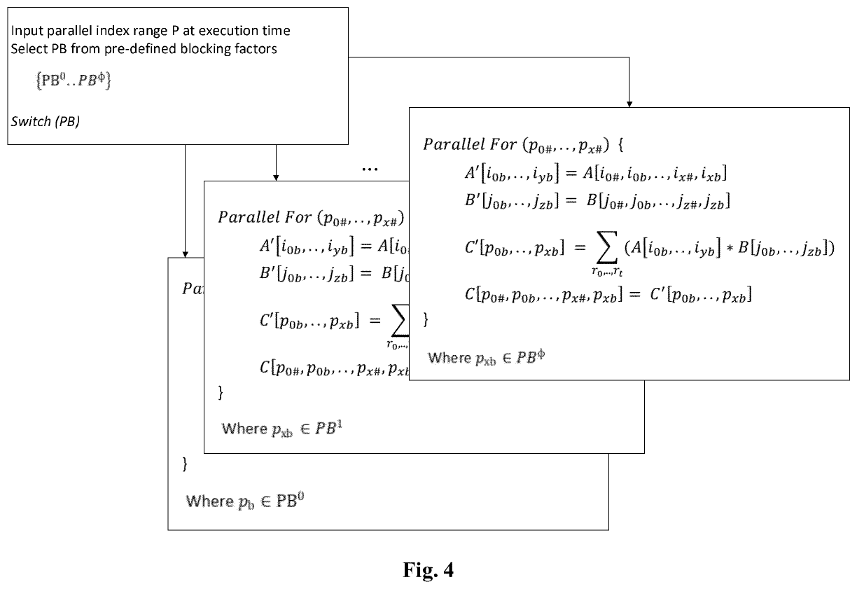

FIG. 4 shows a schematic diagram illustrating an implementation to parallelize compute-intensive operation on input tensors with dynamic shapes according to some embodiments of the disclosure.

FIG. 4 is to be described in combination with FIG. 1. The compiler 130 can obtain a particular parallel index range P and a set of candidate blocking factors {PB⁰ . . . PB^{φ}} for the particular parallel index range P, and then switch one of the candidate blocking factors {PB⁰ . . . PB^{φ}}. A kernel corresponding to the particular parallel index range P and each of the candidate blocking factors (as shown, p_{b}∈PB⁰, p_{b}∈PB¹, . . . , p_{b}∈PB^{φ}) can be generated in parallel by the kernel generator 132. Similarly as the static shape situation, each generated kernel may include a parallel outer loop and an inner loop with a single-core kernel implementing a part of the deep learning operation working on corresponding parts of the input tensors.

The compiler 130 may further include a composer 134 to compose the kernels generated by the kernel generator 132 into compiled codes for execution.

A naïve compiler implementation generates all possible kernels and then dispatch to the one with best estimated performance at the runtime. In order to improve the performance of the compiler, in some embodiments, a part of shape information may be known at compilation time. The partial shape information can be used to reduce choices of blocking factors and corresponding single-core kernels to reduce the binary size. For example, in a deep learning situation, where the reduction indexes are constant and the blocking factors for each parallel index is predefined, they decide shapes of input and output sub-tensors for the corresponding single-core kernel, so the single-core kernel can be pre-built and specialized for the constant indexes. The blocking factors candidates make sure that the tensor shapes can be further blocked to be aligned with register and cache line sizes to fit hardware and ensure the overall size big enough to allow the single-core kernel to be efficient. Based on the pre-built single-core kernel, the compiler generates the whole kernel with the parallel outer loops which breaks any given parallel index range into many sub-ranges and fit them to the single-core kernel. For each possible combination of pre-defined blocking factors of each parallel index, there is one corresponding kernel.

In some embodiments, there may a scenario where the reduction index loops should also be blocked due to not enough parallel subtasks created from blocking the parallel index loops. In this scenario, the reduction index of the deep learning operation (such as, the K dimension of a Matmul operation) may be blocked with a technique known as K-slicing. For example, the compiler 130 can calculate a single-core kernel cost for the single-core kernel obtained by only blocking the parallel index loops, and determine whether the single-core kernel cost is beyond a threshold. The compiler 130 can calculate the single-core kernel cost for the single-core kernel based on any combination of a corresponding blocking factor (PB), a corresponding reduction index range (R), and micro-architecture information (uArch_info). The single_kernel_cost can be adjusted to reflect extra memory use for the single core kernel and extra reduction operation. The threshold may be predetermined and may be related to a size of a subtask and the number of subtasks, which is not limited herein. If the single-core kernel cost is beyond the threshold, the reduction index should be sliced to create more parallel subtasks, the preprocessing component 120 can infer, from the profile of tensor shapes, a profile of reduction index ranges and a probability for each of the reduction index ranges, and determine a set of candidate slicing factors for each of the reduction index ranges; and the kernel generator 132 can generate the kernel for the deep learning operation under a combination of each of the candidate blocking factors and each of the candidate slicing factors.

This K-slice technique can be applied to any reduction index which has a direct mapping to the tensor indexes of both input tensors.

There may also be an extreme scenario where the parallel index range of the deep learning operation is very small but the reduction index range is large, for example, the K dimension of the Matmul operation is large while the M or N dimension is relatively small. In this scenario, blocking the parallel index may be in effective and the reduction index should be blocked to create enough parallel subtasks.

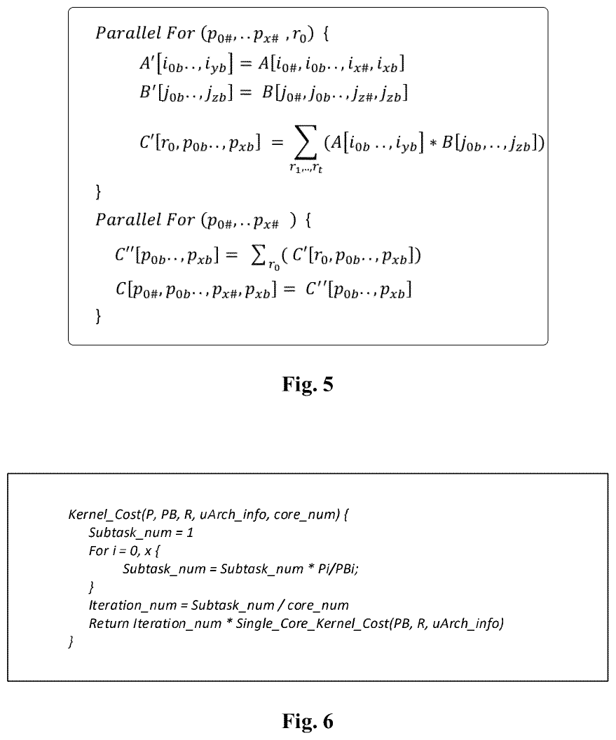

FIG. 5 shows an exemplary pseudo code describing how the parallel loop for the parallel index (p) can be transformed to parallelize the reduction index (r₀), according to some embodiments of the disclosure. In this case, the reduction index r0 can be viewed as promoted as parallel index. The original parallel loop can be viewed as a special case where the blocking factors for reduction indexes are the same as the size of reduction index ranges, and thus no blocking on the reduction indexed is actually happening. For the reduction index being promoted as the parallel index, the single_kernel_cost needs to be adjusted to reflect the extra memory use for the single core kernel and extra reduction operation.

Return to FIG. 1. After the compiler 130 generates the compiled code, the executor 140 can execute the compiled code to perform the deep learning operation on particular workloads.

At execution time, the I/O interfaces 110 can obtain input tensors on which the deep learning operation is to be performed from a memory or input device. The preprocessing component 120 can determine shape information of the input tensors, and determine a parallel index range based on the shape information of the input tensors.

After received the determined parallel index range, the executor 140 can find, in the compiled code, a set of candidate blocking factors for the parallel index range and candidate kernels corresponding to the candidate blocking factors, estimate a kernel cost of for each of the corresponding candidate kernels, and dispatch one of the corresponding candidate kernels that has a minimal kernel cost to perform the deep learning operation on the input tensors.

FIG. 6 shows an exemplary pseudo code for calculating the kernel cost for each of the corresponding candidate kernels, according to some embodiments of the disclosure.

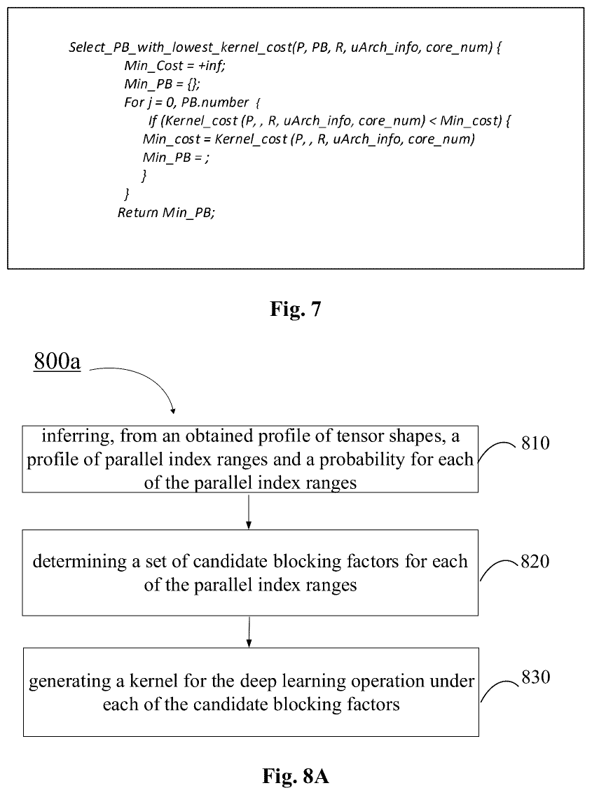

The executor 140 can dispatch the kernel based on the estimated kernel costs, for example, select a kernel with the lowest estimated kernel cost. FIG. 7 shows an exemplary pseudo code for selecting, for the determined parallel index range P, the blocking factor PB from a set of pre-defined block factors {PB⁰ . . . PB^{φ}}, according to some embodiments of the disclosure.

Under a condition that the parallel index range is not divisible or divided evenly by a blocking factor of the dispatched kernel (i.e., a reminder of the parallel index range over the blocking factor of the dispatched kernel is not zero), the executor is further configured to pad slices of the input tensors (so as to be in a computer-friendly size) before feeding them into a single-core kernel of the dispatched kernel and unpad obtained results before saving them back to corresponding slices of a output tensor. With the padding and unpadding, the generated code can work for any dynamic tensor shape at the cost of processing unused data elements. The padding and unpadding cost can be minimized on hardware which does maskload for padding and maskstore for masking out the unused data element.

Using the system 100, the disclosure can operate workloads with dynamic shapes by multiple kernel implementations, and each kernel implementation having single-core kernels with static input and output tensor shapes. As such, each single-core kernel with static tensor shapes can be fused with neighbor operations. Therefore, the technique described herein can be used to support fusing of a compute-intensive operation with a neighbor memory-intensive operation.

The complier 130 and executor 140 of the system 100 can be implemented in hardware, software, or a combination thereof, and they can be implemented on one processor/processing circuitry, or different processors/processing circuitry, which is not limited herein.

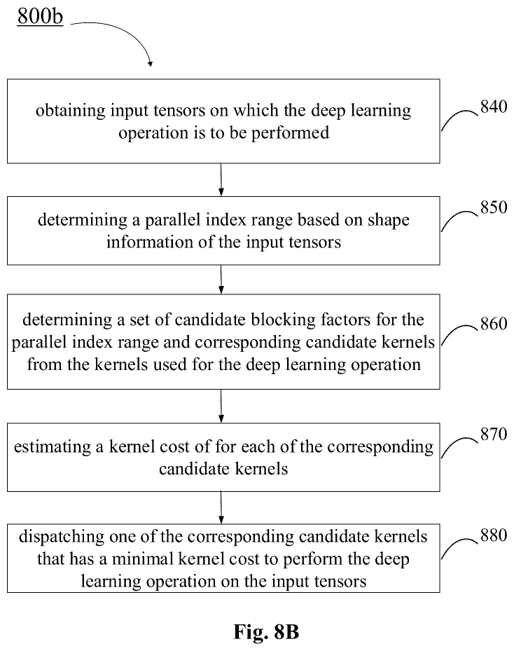

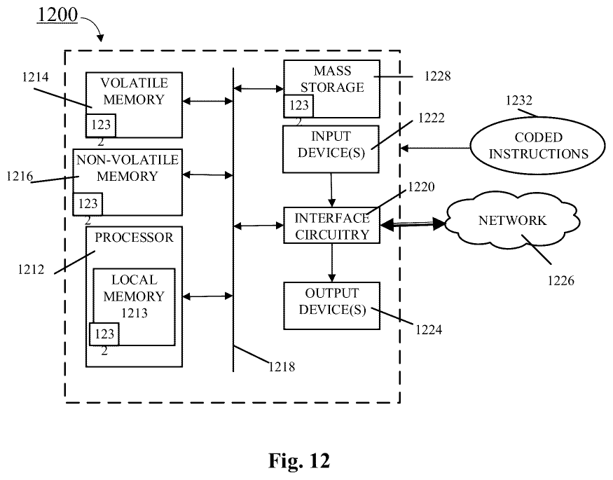

FIG. 8A shows a flowchart of a process 800a for generating kernels used for a deep learning operation on workloads with dynamic shapes, according to some embodiments of the disclosure. FIG. 8B shows a flowchart of a process 800b for performing the deep learning operation on input tensors using the kernels generated by the process 800a, according to some embodiments of the disclosure. The processes 800a and 800b may be implemented, for example, by the system 100 of FIG. 1, by one or more processors of any computing device. An example of the processors is to be shown in FIG. 12.

As shown in FIG. 8A, the process 800a includes, at block 810, inferring, from an obtained profile of tensor shapes, a profile of parallel index ranges and a probability for each of the parallel index ranges. In the present disclosure, it is assumed that the profile of tensor shapes for the workloads with dynamic shapes can be obtained from a memory/storage device or input device.

The process 800a includes, at block 820, determining a set of candidate blocking factors for each of the parallel index ranges. The set of candidate blocking factors for each of the parallel index ranges can be determined, for example, based on an estimated kernel cost corresponding to each potential blocking factor for each of the parallel index ranges.

The process 800a includes, at block 830, generating a kernel for the deep learning operation under each of the candidate blocking factors. The kernel for the operation may include a parallel outer loop and an inner loop with a single-core kernel implementing a part of the deep learning operation working on corresponding parts of the workloads.

As shown in FIG. 8B, the process 800b includes, at block 840, obtaining input tensors on which the deep learning operation is to be performed.

The process 800b includes, at block 850, determining a parallel index range based on shape information of the input tensors.

The process 800b includes, at block 860, determining a set of candidate blocking factors for the parallel index range and corresponding candidate kernels from the kernels used for the deep learning operation, which are generated by the process 800a.

The process 800b includes, at block 870, estimating a kernel cost of for each of the corresponding candidate kernels.

The process 800b includes, at block 880, dispatching one of the corresponding candidate kernels that has a minimal kernel cost to perform the deep learning operation on the input tensors.

More particularly, the process 800a of FIG. 8A and the process 800b of FIG. 8B may be implemented in one or more modules as a set of logic instructions stored in a machine-readable or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the process 800a of FIG. 8A and the process 800b of FIG. 8B may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

In order to facilitate understanding of the technique described herein, a particular implementation using the technique is provided below.

For a two-dimensional (2D) Matmul operation, there are two operators, i.e., matrix A with indexes m and k, and matrix B with indexes k and n, for which, a shape of B is known and a shape of A is not known. For example, ranges K and N of indexes k and n are 1024 and 2048, respectively, and a range M of the index m is a runtime constant.

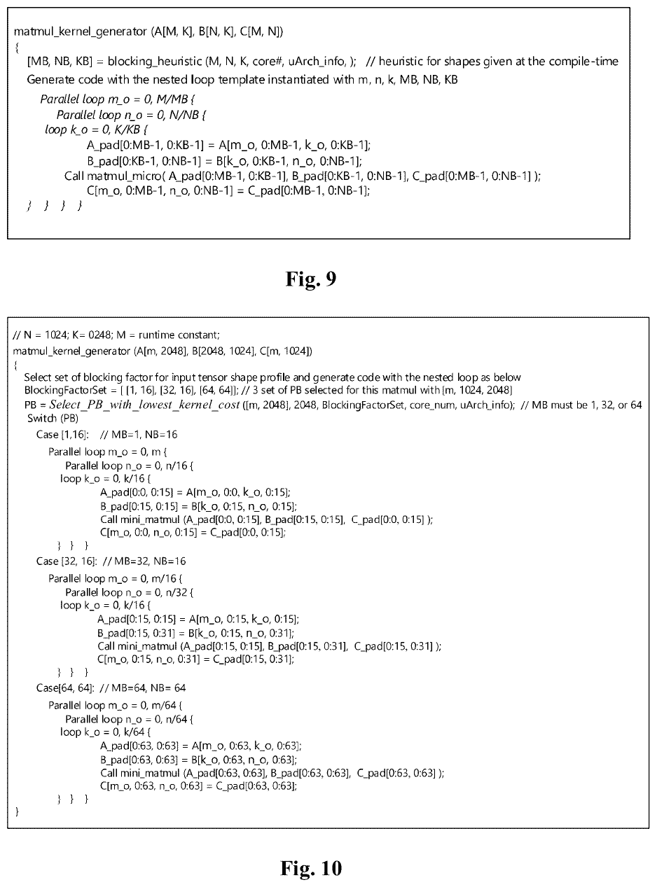

FIG. 9 shows an exemplary pseudo code for generating a kernel for the Matmul operation by a traditional compiler according to some embodiments of the disclosure. It is supposed that the input matrix shapes are [M, K], [K, N], and output matrix shape is [M, N]. The traditional compiler can decompose the Matmul operation to a nested loop nest of matmul microkernels. M, K, N are provided at the compilation time, so the compiler generates specialized code according to the shape information. Firstly, the compiler uses heuristic to block M, N, K dimension by blocking factors MB, NB, and KB. In the pseudo code of FIG. 9, m_o, n_o, and k_o are used as the loop index for the blocked dimension. A [m_o, 0:MB-1, k_o, 0:KB-1] refers to a submatrix with size [MB-1, KB-1] indexed by m_o and k_o in the original matrix A, and matmul_micro kernel works on submatrix of A and B and output a submatrix of C on a single processing unit.

As can be seen, the generated code in FIG. 9 includes a micro-kernel, which is specialized according to the blocking factor MB, NB, and KB. These blocking factors decide the input sub-matrix shapes of the micro-kernel. For each input sub-matrix shape, the micro-kernel is specialized since the internal implementation of the loop assumes that the input sub-matrix shape does not change.

The blocking heuristic identifies a blocking factor for a given shape, core number, and micro-architecture information. Since the M, N, K is provided at compilation time, the compiler uses heuristics to decide blocking factors fitting to the given shape size, and then generates the nested loop specialized for the blocking factors.

FIG. 10 shows an exemplary pseudo code for generating kernels used for the Matmul operation, for which a part of shape information is unknown, according to some embodiments of the disclosure. As mentioned above, for Matmul operation, N=1024, K=2048, and M is a runtime constant. According to the techniques provided herein, a pre-defined set of blocking factors for parallel indexes is selected as [1, 2, 4, 8, 16, 32, 48, 64]. So a full combination of blocking factors for the parallel indexes (m and n) is 64. With the partial shape information, a compiler is able to select a few combinations from the full set, for example, 3 combinations that can correspond to 3 pre-defined kernels. With the full shape information, the generated code first decides the final blocking factor from the 3 blocking factors, and chooses the corresponding case which contains the kernel implementation with parallel loops with the single-core kernel.

The Select_PB_with_lowest_kernel_cost ( ) function chooses a specific blocking factor from the set of candidate blocking factors associated with the operation. The criteria used is to choose the blocking factor which gives the lowest kernel_cost. Then the kernel switches to the implementation specialized to the selected blocking factor.

According to the above embodiments, a range of single-core kernels is built firstly, which are specialized for pre-defined shape sizes, a subset of single-core kernels may be selected from the range of single-core kernels based on partial shape information, and a high-performance parallel code with multiple optional paths with these selected single-core kernels may be composed. At execution time, blocking factors may be determined based on full shape information of input tensors, and then one optimal path is chosen accordingly. The high performance code for dynamic tensor shapes generated by the approach of the present disclosure can be fused by the compiler with neighbor operations within a DNN graph. Techniques of the present disclosure can minimize the compilation time for model with dynamic input tensor shapes and can be used to support ahead of time compilation use case.

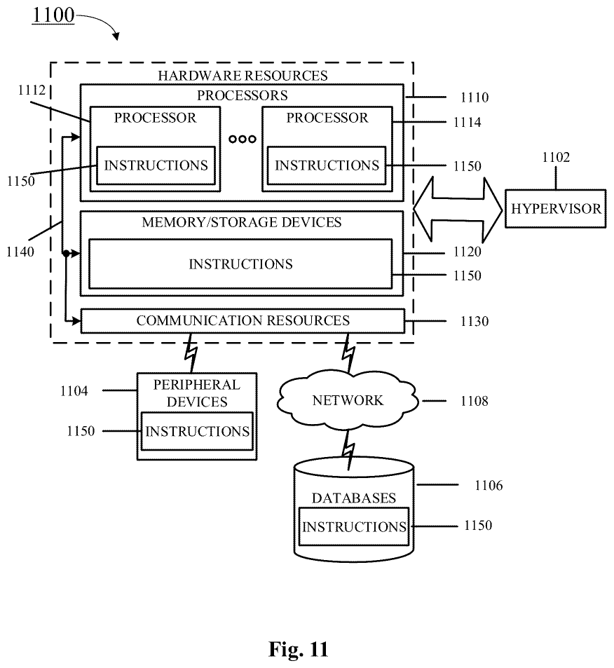

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114 which may be, e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof.

The memory/storage devices 1120 may include main memory, disk storage, or any suitable combination thereof. The memory/storage devices 1120 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1130 may include interconnection or network interface components or other suitable devices to communicate with one or more peripheral devices 1104 or one or more databases 1106 via a network 1108. For example, the communication resources 1130 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

FIG. 12 is a block diagram of an example processor platform in accordance with some embodiments of the disclosure. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes interface circuitry 1220. The interface circuitry 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuitry 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 1220 of the illustrated example, thus, typically includes a graphics driver card, a graphics driver chip and/or a graphics driver processor.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 1220 may include a training dataset inputted through the input device(s) 1222 or retrieved from the network 1226.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and digital versatile disk (DVD) drives.

Machine executable instructions 1232 may be stored in the mass storage device 1228, in the volatile memory 1214, in the non-volatile memory 1216, and/or on a removable non-transitory computer readable storage medium such as a CD or DVD.

The following paragraphs describe examples of various embodiments.

Example 1 includes an apparatus for a deep learning operation on workloads with dynamic shapes, comprising: interface circuitry configured to obtain a profile of tensor shapes; and processing circuitry coupled to the interface circuitry and configured to: infer, from the profile of tensor shapes, a profile of parallel index ranges and a probability for each of the parallel index ranges; determine a set of candidate blocking factors for each of the parallel index ranges; and generate a kernel for the deep learning operation under each of the candidate blocking factors, the kernel for the operation comprising a parallel outer loop and an inner loop with a single-core kernel implementing a part of the deep learning operation working on corresponding parts of the workloads.

Example 2 includes the apparatus of Example 1, wherein the processing circuitry is further configured to determine the set of candidate blocking factors for each of the parallel index ranges based on an estimated kernel cost corresponding to each potential blocking factor for each of the parallel index ranges.

Example 3 includes the apparatus of Example 1 or Example 2, wherein the processing circuitry is further configured to: estimate a single-core kernel cost for the single-core kernel, based on any combination of a corresponding blocking factor, a corresponding reduction index range, and micro-architecture information; and determine whether the single-core kernel cost is beyond a threshold.

Example 4 includes the apparatus of Example 3, wherein under a condition that the single-core kernel cost is beyond the threshold, the processing circuitry is further configured to: infer, from the profile of tensor shapes, a profile of reduction index ranges and a probability for each of the reduction index ranges; determine a set of candidate slicing factors for each of the reduction index ranges; and generate the kernel for the deep learning operation under a combination of each of the candidate blocking factors and each of the candidate slicing factors.

Example 5 includes the apparatus of any of Examples 1-4, wherein a part of shape information of the dynamic shapes is known at compilation time to reduce a number of candidate blocking factors, and in turn a number of candidate kernels.

Example 6 includes the apparatus of any of Examples 1-5, wherein the interface circuitry is further configured to obtain input tensors on which the deep learning operation is to be performed; and the processing circuitry is further configured to: determine a parallel index range based on shape information of the input tensors; determine a set of candidate blocking factors for the parallel index range and corresponding candidate kernels; estimate a kernel cost of for each of the corresponding candidate kernels; and dispatch one of the corresponding candidate kernels that has a minimal kernel cost to perform the deep learning operation on the input tensors.

Example 7 includes the apparatus of Example 6, wherein the kernel cost for each of the corresponding candidate kernels is determined by any combination of the parallel index range, a corresponding blocking factor, a reduction index range, micro-architecture information and a number of cores.

Example 8 includes the apparatus of Example 6, wherein under a condition that the parallel index range is not divisible by a blocking factor of the dispatched kernel, the processing circuitry is further configured to pad slices of the input tensors before feeding them into a single-core kernel of the dispatched kernel and unpad obtained results before saving them back to corresponding slices of a output tensor.

Example 9 includes the apparatus of Example 8, wherein the padding and unpadding are implemented by hardware instructions maskload and maskstore, respectively.

Example 10 includes the apparatus of any of Examples 1-9, wherein the deep learning operation is allowed to be fused with a neighbor operation.

Example 11 includes the apparatus of Example 10, wherein the deep learning operation comprises a compute-intensive operation and the neighbor operation comprises a memory-intensive operation.

Example 12 includes the apparatus of any of Examples 1-11, wherein the set of candidate blocking factors for each of the parallel index ranges is selected from 1, 2, 4, 8, 16, 32, 48, and 64.

Example 13 includes a method for a deep learning operation on workloads with dynamic shapes, comprising: inferring, from a profile of tensor shapes, a profile of parallel index ranges and a probability for each of the parallel index ranges; determining a set of candidate blocking factors for each of the parallel index ranges; and generating a kernel for the deep learning operation under each of the candidate blocking factors, the kernel for the operation comprising a parallel outer loop and an inner loop with a single-core kernel implementing a part of the deep learning operation working on corresponding parts of the workloads.

Example 14 includes the method of Example 13, wherein the set of candidate blocking factors for each of the parallel index ranges is determined based on an estimated kernel cost corresponding to each potential blocking factor for each of the parallel index ranges.

Example 15 includes the method of Example 13 or Example 14, further comprising: estimating a single-core kernel cost for the single-core kernel, based on any combination of a corresponding blocking factor, a corresponding reduction index range, and micro-architecture information; and determining whether the single-core kernel cost is beyond a threshold.

Example 16 includes the method of Example 15, further comprising: under a condition that the single-core kernel cost is beyond the threshold: inferring, from the profile of tensor shapes, a profile of reduction index ranges and a probability for each of the reduction index ranges; determining a set of candidate slicing factors for each of the reduction index ranges; and generating the kernel for the deep learning operation under a combination of each of the candidate blocking factors and each of the candidate slicing factors.

Example 17 includes the method of any of Examples 13-16, wherein a part of shape information of the dynamic shapes is known at compilation time to reduce a number of candidate blocking factors, and in turn a number of candidate kernels.

Example 18 includes the method of any of Examples 13-17, further comprising: obtaining input tensors on which the deep learning operation is to be performed; determining a parallel index range based on shape information of the input tensors; determining a set of candidate blocking factors for the parallel index range and corresponding candidate kernels; estimating a kernel cost of for each of the corresponding candidate kernels; and dispatching one of the corresponding candidate kernels that has a minimal kernel cost to perform the deep learning operation on the input tensors.

Example 19 includes the method of Example 18, wherein the kernel cost for each of the corresponding candidate kernels is determined by any combination of the parallel index range, a corresponding blocking factor, a reduction index range, micro-architecture information and a number of cores.

Example 20 includes the method of Example 18, wherein under a condition that the parallel index range is not divisible by a blocking factor of the dispatched kernel, the method further comprises padding slices of the input tensors before feeding them into a single-core kernel of the dispatched kernel and unpadding obtained results before saving them back to corresponding slices of a output tensor.

Example 21 includes the method of 20, wherein the padding and unpadding are implemented by hardware instructions maskload and maskstore, respectively.

Example 22 includes the method of any of Examples 13-21, wherein the deep learning operation is allowed to be fused with a neighbor operation.

Example 23 includes the method of any of Examples 13-22, wherein the deep learning operation comprises a compute-intensive operation and the neighbor operation comprises a memory-intensive operation.

Example 24 includes the method of any of Examples 13-23, wherein the set of candidate blocking factors for each of the parallel index ranges is selected from 1, 2, 4, 8, 16, 32, 48, and 64.

Example 25 includes a machine readable storage medium having instructions stored thereon, the instructions when executed by a machine, causing the machine to perform the method of any one of claims 13 to 24.

Example 26 includes a computing device, comprising means for performing the method of any one of claims 13 to 24.

Example 27 includes an apparatus comprising one or more processors to implement the one or more of the processes as shown and described in the description.

Example 28 includes a method comprising one or more of processes as shown and described in the description.

Example 29 includes a system comprising one or more memories to store computer-readable instructions for implementing one or more of the processes as shown and described in the description.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. The disclosure is intended to cover any adaptations or variations of the embodiments discussed herein. Therefore, it is manifestly intended that embodiments described herein be limited only by the appended claims and the equivalents thereof.

1-25. (canceled)

26. An apparatus for a deep learning operation on workloads with dynamic shapes, the apparatus comprising:
interface circuitry to obtain a profile of tensor shapes;
instructions; and
at least one processor circuit to be programmed based on the instructions to:
infer, from the profile of tensor shapes, a profile of parallel index ranges and a probability for each of the parallel index ranges;
determine a set of candidate blocking factors for each of the parallel index ranges; and
generate a kernel for the deep learning operation under each of the candidate blocking factors, the kernel for the deep learning operation including a parallel outer loop and an inner loop with a single-core kernel implementing a part of the deep learning operation working on corresponding parts of the workloads.

27. The apparatus of claim 26, wherein one or more of the at least one processor circuit is to determine the set of candidate blocking factors for each of the parallel index ranges based on an estimated kernel cost corresponding to each potential blocking factor for each of the parallel index ranges.

28. The apparatus of claim 26, wherein one or more of the at least one processor circuit is to:
estimate a single-core kernel cost for the single-core kernel based on at least one of a corresponding blocking factor, a corresponding reduction index range, or micro-architecture information; and
determine whether the single-core kernel cost is beyond a threshold.

29. The apparatus of claim 28, wherein under a condition that the single-core kernel cost is beyond the threshold, one or more of the at least one processor circuit is to:
infer, from the profile of tensor shapes, a profile of reduction index ranges and a probability for each of the reduction index ranges;
determine a set of candidate slicing factors for each of the reduction index ranges; and
generate the kernel for the deep learning operation under a combination of each of the candidate blocking factors and each of the candidate slicing factors.

30. The apparatus of claim 26, wherein a part of shape information of the dynamic shapes is known at compilation time to reduce a number of candidate blocking factors, and in turn a number of candidate kernels.

31. The apparatus of claim 26, wherein the interface circuitry is to obtain input tensors on which the deep learning operation is to be performed; and
one or more of the at least one processor circuit is to:
determine a parallel index range based on shape information of the input tensors;
determine a set of candidate blocking factors for the parallel index range and corresponding candidate kernels;
estimate a kernel cost for each of the corresponding candidate kernels; and
dispatch one of the corresponding candidate kernels that has a minimal kernel cost to perform the deep learning operation on the input tensors.

32. The apparatus of claim 31, wherein the kernel cost for each of the corresponding candidate kernels is determined based on at least one of the parallel index range, a corresponding blocking factor, a reduction index range, micro-architecture information or a number of cores.

33. The apparatus of claim 31, wherein under a condition that the parallel index range is not divisible by a blocking factor of the dispatched kernel, one or more of the at least one processor circuit is to pad slices of the input tensors before feeding them into a single-core kernel of the dispatched kernel and unpad obtained results before saving them back to corresponding slices of a output tensor.

34. The apparatus of claim 33, wherein the padding and unpadding are implemented by hardware instructions maskload and maskstore, respectively.

35. The apparatus of claim 26, wherein the deep learning operation is allowed to be fused with a neighbor operation.

36. The apparatus of claim 35, wherein the deep learning operation includes a compute-intensive operation and the neighbor operation includes a memory-intensive operation.

37. The apparatus of claim 26, wherein the set of candidate blocking factors for each of the parallel index ranges is selected from 1, 2, 4, 8, 16, 32, 48, and 64.

38. A method for a deep learning operation on workloads with dynamic shapes, the method comprising:
inferring, from a profile of tensor shapes, a profile of parallel index ranges and a probability for each of the parallel index ranges;
determining a set of candidate blocking factors for each of the parallel index ranges; and
generating, by at least one processor circuit programmed by at least one instruction, a kernel for the deep learning operation under each of the candidate blocking factors, the kernel for the operation including a parallel outer loop and an inner loop with a single-core kernel implementing a part of the deep learning operation working on corresponding parts of the workloads.

39. The method of claim 38, wherein the determining of the set of candidate blocking factors for each of the parallel index ranges is based on an estimated kernel cost corresponding to each potential blocking factor for each of the parallel index ranges.

40. The method of claim 38, including:
estimating a single-core kernel cost for the single-core kernel based on at least one of a corresponding blocking factor, a corresponding reduction index range, or micro-architecture information; and
determining whether the single-core kernel cost is beyond a threshold.

41. The method of claim 40, including:
under a condition that the single-core kernel cost is beyond the threshold:
inferring, from the profile of tensor shapes, a profile of reduction index ranges and a probability for each of the reduction index ranges;
determining a set of candidate slicing factors for each of the reduction index ranges; and
generating the kernel for the deep learning operation under a combination of each of the candidate blocking factors and each of the candidate slicing factors.

42. The method of claim 38, wherein a part of shape information of the dynamic shapes is known at compilation time to reduce a number of candidate blocking factors, and in turn a number of candidate kernels.

43. The method of claim 38, including:
obtaining input tensors on which the deep learning operation is to be performed;
determining a parallel index range based on shape information of the input tensors;
determining a set of candidate blocking factors for the parallel index range and corresponding candidate kernels;
estimating a kernel cost for each of the corresponding candidate kernels; and
dispatching one of the corresponding candidate kernels that has a minimal kernel cost to perform the deep learning operation on the input tensors.

44. The method of claim 43, wherein the kernel cost for each of the corresponding candidate kernels is determined based on at least one of the parallel index range, a corresponding blocking factor, a reduction index range, micro-architecture information or a number of cores.

45. A non-transitory computer-readable medium comprising instructions to cause at least one processor circuit to at least:
infer, from a profile of tensor shapes, a profile of parallel index ranges and a probability for each of the parallel index ranges;
determine a set of candidate blocking factors for each of the parallel index ranges; and
generate a kernel for a deep learning operation under each of the candidate blocking factors, the kernel for the operation including a parallel outer loop and an inner loop with a single-core kernel implementing a part of the deep learning operation working on corresponding parts of workloads with dynamic shapes.
